(19) United States
(12) Patent Application Publication
(10) Pub. No.: US 2002/0152296 A1
(43) Pub. Date: Oct. 17, 2002

(54) Optimization of a fleet of output devices

(76) Inventor: Jonathan Baker, Boise, ID (US)

Correspondence Address: HEWLETT-PACKARD COMPANY, Intellectual Property Administration, P. O. Box 272400, Fort Collins, CO, 80527-2400, US

(21) Appl. No.: 09/835,738

(22) Filed: Apr. 16, 2001

(51) Int. Cl. G06F 15/173

(52) U.S. Cl. 709/223

(57) ABSTRACT

Output device utilization on a network is optimized. Utilization information for each output device is tracked. The utilization information is tracked by periodically retrieving the utilization information and archiving the retrieved utilization information. The utilization information is selectively tracked from network print clients, network print servers and network output devices. The utilization information is analyzed for optimization opportunities. The utilization information is analyzed by selectively searching for underused and overused output devices. The utilization information is analyzed for optimization opportunities by applying rules to the utilization information. The rules are applied to the utilization information by selectively optimizing for lowest cost, highest quality, soonest output and output closest to an originated print client. The network is configured to exploit the optimization opportunities. The network is configured by selectively configuring network print clients, network print servers and network output devices.

### FIELD OF THE INVENTION

This invention relates in general to optimization of a fleet of output devices and, more particularly, to optimizing the fleet using historic data.

### BACKGROUND OF THE INVENTION

Network printers have been utilized for several years. Each network printer communicates with a network of print clients. The print clients direct print jobs to the network printers where the print jobs are processed and output.

A frequent occurrence is that the printing load is unbalanced. For instance, one or more printers is underutilized while other printers are overburdened with print jobs. It is desirable to balance the printing load so that the most effective use is made of the network printers.

One conventional solution for balancing the printer load is to track the load of each printer and route each printer job to the most desirable printer. An expected print time for each printer may be calculated and then the job delivered to the output device having the lowest expected print time. One drawback to this approach is that a decision must be made for each print job. Additionally, the workload status of each printer must be monitored.

### SUMMARY OF THE INVENTION

According to principles of the present invention, output device utilization on a network is optimized. Utilization information for each output device is tracked. The utilization information is analyzed for optimization opportunities.

The network is configured to exploit the optimization opportunities.

According to further principles of the present invention, the utilization information is tracked by periodically retrieving the utilization information and archiving the retrieved utilization information. The utilization information is selectively tracked from network print clients, network print servers and network output devices.

According to further principles of the present invention, the utilization information is analyzed by selectively searching for underused and overused output devices. The utilization information is analyzed for optimization opportunities by applying rules to the utilization information. The rules are applied to the utilization information by selectively optimizing for lowest cost, highest quality, soonest output and output closest to an originated print client.

According to further principles of the present invention, the network is configured by selectively configuring network print clients, network print servers and network output devices.

### DESCRIPTION OF THE DRAWINGS

FIG. 1 is a block diagram representing one embodiment of the system of the present invention for posting a document.

FIG. 2 is a flow chart illustrating one embodiment of the method of the present invention for posting a document.

FIG. 3 is a diagrammatic illustration representing one embodiment of the system and method of the present invention for posting a document.

### DETAILED DESCRIPTION OF THE INVENTION

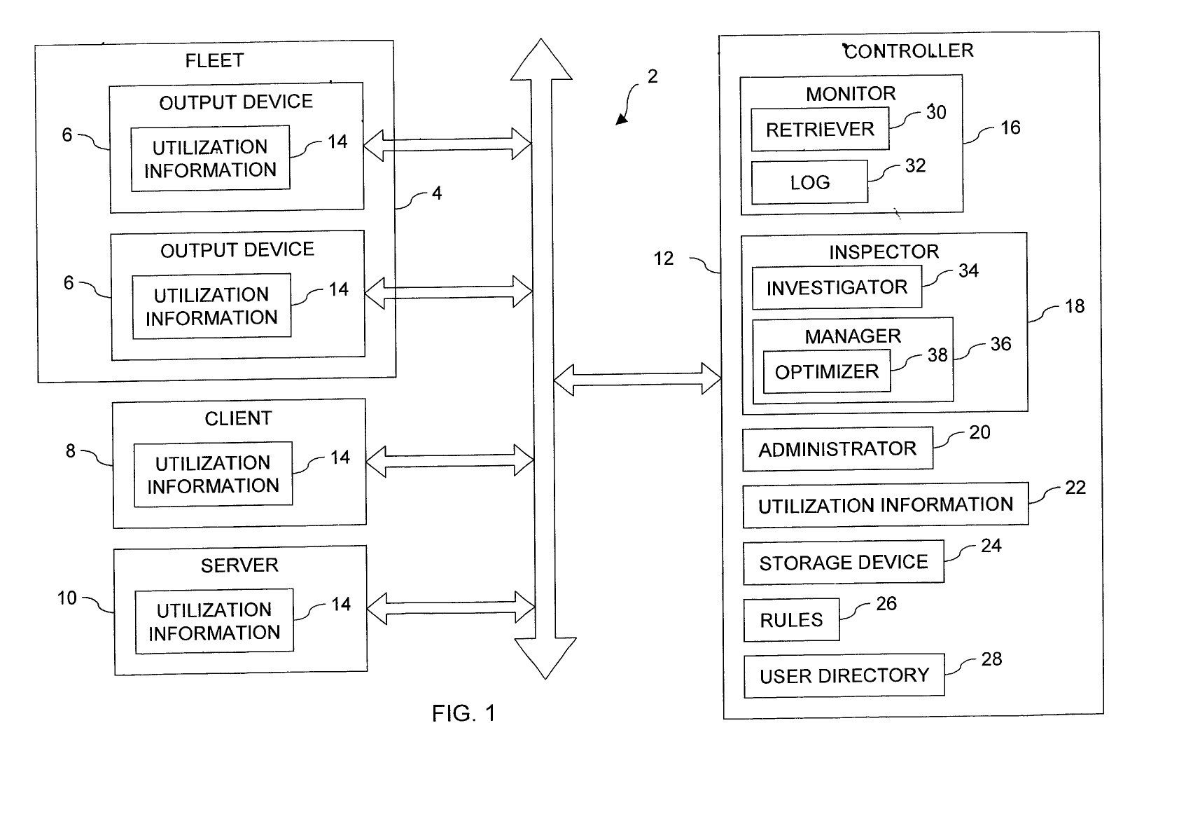

Illustrated in FIG. 1 is a network 2 including a fleet 4 of at least one output device 6. Network 2 further includes at least one print client 8, at least one print server 10 and at least one controller 12. For clarity, this description will generally refer to only one of each of these components 6, 8, 10 of network 2.

Output device 6 is any device that produces output onto print media. Examples of output device 6 include a printer, a copier, a facsimile machine and a multifunction device.

Print client 8 is any device or system, such as a specific or general purpose computer, that includes a means, such as a processor, for processing executable code.

Print server 10 is any device or system acting as a server for output device 6. Server 10 receives print jobs from print client 8 and posts then to output device 6.

Accessible by each of output device 6, print client 8, and print server 10 is utilization information 14 for output device 6. It is anticipated that utilization information 14 will include different information about each of output device 6, print client 8, and print server 10. For example, utilization information 14 on output device 6 may include information concerning actual pages printed and other information easily recordable by output device 6. Utilization information 14 on print client 8 may include information the number of print jobs originating from print client 8 directed to output device 6 and other information easily recordable by print client 8. Utilization information 14 on print server 10 may include the number of print jobs routed to through print server 10 to output device 6.

Controller 12 is any combination of hardware and executable code for controlling the optimization of fleet 4 of output devices 6. Controller 12 is embodied on any of output device 6, client 8, server 10, or some other device. Controller 12 includes monitor 16, inspector 18, administrator 20, utilization information 22 and, optionally, storage device 24, rules 26 and user directory 28. While FIG. 1 illustrates controller 12 embodied in a single device, controller 12 may alternatively be embodied in multiple separate devices. Utilization information 22 is aggregated historical utilization information 14 retrieved from output device 6, print client 8 and print server 10.

Monitor 16 is any combination of hardware and executable code configured to track utilization information 14 for each output device 6. Specifically, monitor 16 may be configured to track utilization information 14 by selectively tracking from network print clients 8, network print servers 10 and network output devices 6.

In one embodiment, monitor 16 includes retriever 30 and utilization log 32. Retriever 30 is any combination of hardware and executable code configured to periodically retrieve the utilization information 14. Utilization log 32 is any combination of hardware and executable code configured to archive the retrieved utilization information 14.

Inspector 18 is any combination of hardware and executable code configured to analyze the utilization information 22 for optimization opportunities. In one embodiment, inspector 18 includes investigator 34.

Investigator 34 is any combination of hardware and executable code configured to search selectively for underused and overused output devices 6.

In an embodiment non-conflicting with the previous example, inspector 18 includes manager 36. Manager 36 is any combination of hardware and executable code configured to apply rules to the utilization information 22. In one embodiment, manager 36 includes optimizer 38. Optimizer 38 is any combination of hardware and executable code configured to selectively optimize for lowest cost, highest quality, soonest output and output closest to an originating print client 8.

Administrator 20 is any combination of hardware and executable code configured to configure network 2 to exploit the optimization opportunities. Specifically, administrator 20 may be configured to configure network 2 by selectively configuring network print clients 8, network print servers 10 and network output devices 6.

Storage device 24 is any device for storing data or executable code. Each of monitor 16, inspector 18, administrator 20, utilization information 22, rules 26 and user directory 28 may be stored on storage device 24. Storage device 24 may also be a program storage device tangibly embodying a program, applet or instructions executable by controller 12 for performing the method steps of the present invention executable by controller 12. Storage device 24 may be any type of storage media such as magnetic, optical or electronic storage media. Although depicted as integral to controller 12, storage device 24 is alternatively embodied separate from controller 12 and accessible by controller 12.

Rules 26 are any directives for guiding the optimization of fleet 4 of output devices 6. For example rules 26 may require optimization for lowest cost, highest quality, soonest output or output closest to an originating print client 8.

User directory 28 is any index of authorizations for print clients 8 to output devices 6. For example, user directory 28 may allow one subset of clients 8 access to a subset of output devices 6 and another subset of clients 8 access to a different subset of output devices 6.

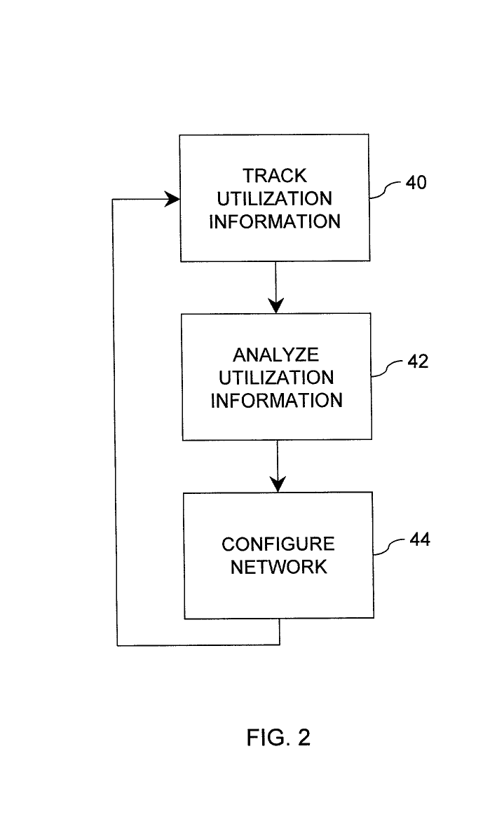

FIG. 2 is a flow chart representing steps of one embodiment of the present invention. Although the steps represented in FIG. 2 are presented in a specific order, the present invention encompasses variations in the order of steps. Furthermore, additional steps may be executed between the steps illustrated in FIG. 2 without departing from the scope of the present invention.

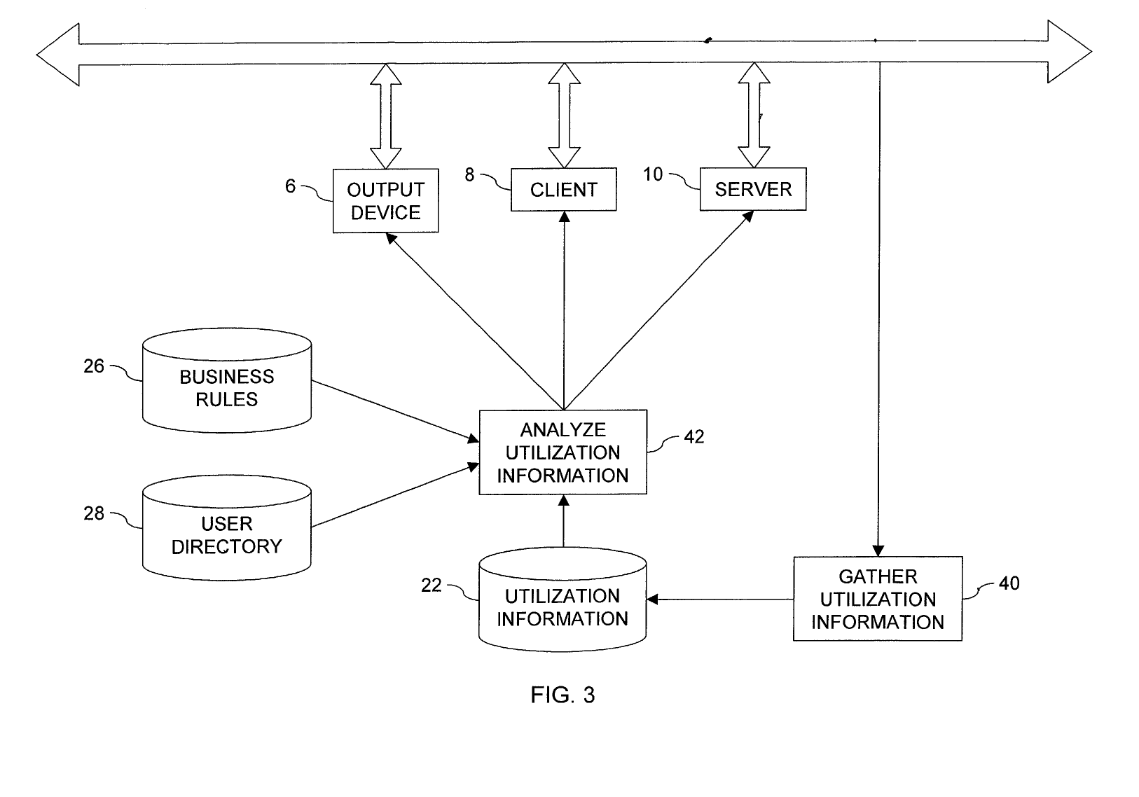

FIG. 3 is a diagram combining portions of FIGS. 1 and 2 in order to further illustrate one embodiment of the present invention. FIGS. 2 and 3 are discussed together.

Utilization information 14 for each output device 6 is tracked 40. In one embodiment, utilization information 14 is tracked 40 by periodically retrieving the utilization information and archiving the retrieved utilization information 14. The utilization information 14 is selectively tracked 40 from network print clients 8, network print servers 10 and network output devices 6.

Utilization information 22 is analyzed 42 for optimization opportunities. In one embodiment, utilization information 22 is analyzed 42 by selectively searching for underused and overused output devices. In a non-conflicting alternate embodiment, utilization information 22 is analyzed 42 for optimization opportunities by applying rules 26 to utilization information 22. Rules 26 are applied to utilization information 22 by selectively optimizing for lowest cost, highest quality, soonest output and output closest to an originated print client.

Network 2 is configured 44 to exploit the optimization opportunities. Network 2 is configured 44 by selectively configuring network print clients 8, network print servers 10 and network output devices 6.

The foregoing description is only illustrative of the invention. Various alternatives and modifications can be devised by those skilled in the art without departing from the invention. Accordingly, the present invention embraces all such alternatives, modifications and variances that fall within the scope of the appended claims.

What is claimed is:

1. A method for optimizing output device utilization on a network including at least one output device, the method comprising:
(a) tracking utilization information for each output device;
(b) analyzing the utilization information for optimization opportunities; and,
(c) configuring the network to exploit the optimization opportunities.

2. The method of claim 1 wherein tracking utilization information includes:
(a) periodically retrieving the utilization information; and,
(b) archiving the retrieved utilization information.

3. The method of claim 1 wherein tracking utilization information includes tracking utilization information selectively from network print clients, network print servers and network output devices.

4. The method of claim 1 wherein analyzing the utilization information includes searching selectively for underused and overused output devices.

5. The method of claim 1 wherein analyzing the utilization information for optimization opportunities includes applying rules to the utilization information.

6. The method of claim 5 wherein applying rules to the utilization information includes selectively optimizing for lowest cost, highest quality, soonest output and output closest to an originating print client.

7. The method of claim 1 wherein configuring the network includes selectively configuring network print clients, network print servers and network output devices.

8. A system for optimizing output device utilization on a network including at least one output device, the system comprising:
(a) a monitor configured to track utilization information for each output device;
(b) an inspector configured to analyze the utilization information for optimization opportunities; and,
(c) an administrator configured to configure the network to exploit the optimization opportunities.

9. The system of claim 8 wherein the monitor includes:
(a) a retriever configured to periodically retrieve the utilization information; and,
(b) a utilization log configured to archive the retrieved utilization information.

10. The system of claim 8 wherein the monitor is further configured to track utilization information selectively from network print clients, network print servers and network output devices.

11. The system of claim 8 wherein the inspector includes an investigator configured to search selectively for underused and overused output devices.

12. The system of claim 8 wherein the inspector includes a manager configured to apply rules to the utilization information.

13. The system of claim 12 wherein the manager includes an optimizer configured to selectively optimize for lowest cost, highest quality, soonest output and output closest to an originating print client.

14. The system of claim 8 wherein the administrator is further configured to selectively configure network print clients, network print servers and network output devices.

15. A program storage device readable by a computer, tangibly embodying a program, applet or instructions executable by the computer to perform method steps for optimizing output device utilization on a network including at least one output devices, the method steps comprising:
(a) tracking utilization information for each output device;
(b) analyzing the utilization information for optimization opportunities; and,
(c) configuring the network to exploit the optimization opportunities.

16. The program storage device of claim 15 wherein the method step of tracking utilization information includes:
(a) periodically retrieving the utilization information; and,
(b) archiving the retrieved utilization information.

17. The program storage device of claim 15 wherein the method step of tracking utilization information includes tracking utilization information selectively from network print clients, network print servers and network output devices.

18. The program storage device of claim 15 wherein the method step of analyzing the utilization information includes searching selectively for underused and overused output devices.

19. The program storage device of claim 15 wherein the method step of analyzing the utilization information for optimization opportunities includes applying rules to the utilization information.

20. The program storage device of claim 15 wherein the method step of configuring the network includes selectively configuring network print clients, network print servers and network output devices.
